(19) United States
(12) Patent Application Publication
(10) Pub. No.: US 2026/0128466 A1
(43) Pub. Date: May 7, 2026

(54) SEPARATOR FOR ELECTROCHEMICAL DEVICE AND ELECTROCHEMICAL DEVICE INCLUDING THE SAME

(71) Applicant: LG ENERGY SOLUTION, LTD., Seoul (KR)

(72) Inventors: Min Ji KIM, Daejeon (KR); Ji Hyeon KIM, Daejeon (KR); Seon Woo HWANG, Daejeon (KR); Kyung Ryun KA, Daejeon (KR); Min Gyu KIM, Daejeon (KR)

(73) Assignee: LG ENERGY SOLUTION, LTD., Seoul (KR)

(21) Appl. No.: 19/376,129

(22) Filed: Oct. 31, 2025

(30) Foreign Application Priority Data
Nov. 1, 2024 (KR) 10-2024-0153212
Sep. 23, 2025 (KR) 10-2025-0137403

(51) Int. Cl. H01M 50/449; H01M 10/052; H01M 50/42; H01M 50/434; H01M 50/443; H01M 50/446; H01M 50/489

(52) U.S. Cl. CPC H01M 50/449; H01M 10/052; H01M 50/42; H01M 50/434; H01M 50/443; H01M 50/446; H01M 50/489

(57) ABSTRACT

The present disclosure provides a separator for an electrochemical device and an electrochemical device employing the same, in which the separator includes a porous polymer substrate and a porous coating layer formed on at least one surface of the porous polymer substrate and containing inorganic particles, and the dielectric constant of the porous coating layer is 250 to 10,000.

### CROSS REFERENCES TO RELATED APPLICATIONS

This application is based on and claims priority from Korean Patent Application No. 10-2024-0153212, filed on Nov. 1, 2024 and Korean Patent Application No. 10-2025-0137403, filed on Sep. 23, 2025, with the Korean Intellectual Property Office, the disclosure of which is incorporated herein in its entirety by reference.

### TECHNICAL FIELD

The present disclosure relates to a separator for an electrochemical device, and an electrochemical device including the same.

### BACKGROUND

An electrochemical device converts chemical energy into electrical energy by using electrochemical reactions. In recent years, lithium secondary batteries, which have a high energy density, a high voltage, and a long cycle life and can be used in various fields, are widely used.

A lithium secondary battery may include an electrode assembly manufactured by combining a positive electrode, a negative electrode, and a separator disposed between the positive electrode and the negative electrode, and may be manufactured by accommodating the electrode assembly, together with an electrolyte, in a case.

### SUMMARY

The present disclosure provides a separator for an electrochemical device and an electrochemical device including the same, in which the stability of the electrochemical device can be improved by adjusting the dielectric constant of a porous coating layer.

Meanwhile, the present disclosure is not limited to the above-mentioned features, and other unmentioned features will be clearly understood by those skilled in the art from the following description.

A separator for an electrochemical device provided in one embodiment of the present disclosure includes a porous polymer substrate, and a porous coating layer formed on at least one surface of the porous polymer substrate and containing inorganic particles, and the dielectric constant of the porous coating layer is about 250 to 10,000.

According to one embodiment of the present disclosure, the inorganic particles may contain BaTiO₃ or SrTiO₃.

According to one embodiment of the present disclosure, the inorganic particles may have a dielectric constant of about 250 to 10,000.

According to one embodiment of the present disclosure, the particle size of the inorganic particles is 300 nm to 1,000 nm.

According to one embodiment of the present disclosure, the crystal structure of the inorganic particles may be tetragonal.

According to one embodiment of the present disclosure, the thickness of the porous coating layer may be about 0.3 μm to 3.0 μm.

According to one embodiment of the present disclosure, the inorganic particles may be included in an amount of about 80 parts to 99 parts by weight relative to 100 parts by weight of the porous coating layer.

According to one embodiment of the present disclosure, the porous coating layer may further include an acrylic binder.

According to one embodiment of the present disclosure, the gas generation amount of the separator for the electrochemical device may be 1,500 μl or less.

An electrochemical device provided in one embodiment of the present disclosure includes a positive electrode, a negative electrode, a separator disposed between the positive electrode and the negative electrode, and an electrolyte. In the electrochemical device, the separator is the separator based on one embodiment of the present disclosure.

The separator for an electrochemical device and the electrochemical device according to the present disclosure may have improved stability.

### DETAILED DESCRIPTION

Hereinafter, each component of the present disclosure will be described in more detail so that those with ordinary knowledge in the technical field to which the present disclosure belongs can easily implement it. However, this is merely an example, and the scope of the present disclosure is not limited by the following contents.

In the present specification, “include” is used to list materials, compositions, devices, and methods useful for the present disclosure, but is not limited to the listed examples.

In the present specification, “electrochemical device” may mean a primary battery, a secondary battery, or a supercapacitor.

In the present specification, the “particle size” refers to a diameter D50 at the point of 50% in the cumulative distribution of the number of particles based on the particle size. The particle size may be measured by using a laser diffraction method. Specifically, a measurement target is dispersed in a dispersion medium, and then is introduced into a commercially available laser diffraction particle size measurement device (e.g., Microtrac S3500). Then, when the particles pass through laser beam, the particle size distribution is calculated by measuring the difference in the diffraction pattern according to the particle size. The particle size may be measured by calculating the particle diameter at the point of 50% in the cumulative distribution of the number of particles based on the particle size, in the measuring device.

The “dielectric constant (permittivity)” in the present specification is a dimensionless physical quantity indicating the magnitude of polarization that a dielectric substance creates in response to an external electric field. The dielectric constant may be measured at a temperature of 25° C. through a standard test method of ASTM D150. Here, the sintering temperature for preparing a specimen may be 1,100° C., and the thickness of a compressed plate may be about 1.55 mm.

The terms “about,” “approximately,” and “substantially” used in the present specification are used to mean the ranges of numerical values or degrees or approximations thereof, taking into account inherent manufacturing and material tolerances (e.g., ±5%).

Among the components of an electrochemical device, a separator includes a porous polymer substrate having a porous structure located between a positive electrode and a negative electrode. The separator serves to prevent an electrical short circuit between the positive electrode and the negative electrode by separating two electrodes from each other while serving to allow an electrolyte and ions to pass therethrough. Although the separator itself does not participate in an electrochemical reaction, physical properties such as wettability to an electrolyte, a degree of porosity, and a thermal shrinkage rate affect the performance and safety of the electrochemical device.

Therefore, in order to enhance the physical properties of the separator, various methods have been attempted, in which a coating layer is added to a porous polymer substrate, and various materials are added to the coating layer so as to change the properties of the coating layer. As an example, in order to improve the mechanical strength of the separator, inorganic substances may be added to the coating layer, or inorganic substances or hydrates for improving the flame retardancy and heat resistance of the porous polymer substrate may be added to the coating layer. Al₂O₃, AlOOH, and the like, which have conventionally been used as heat-resistance imparting inorganic materials, have a characteristic of adsorbing moisture due to functional groups exposed on their surfaces, such as hydroxyl groups and carboxyl groups. This characteristic increases the moisture content of the separator, and contributes to side reactions such as electrolyte decomposition such that gases are generated during assembly, storage, transportation, or operation of the electrochemical device. This has led to problems such as reduction of stability and lifespan of the electrochemical device.

The present disclosure provides a technology of controlling the dielectric constant of a porous coating layer included in a separator of an electrochemical device to improve the stability of the electrochemical device including the separator.

The separator according to one embodiment of the present disclosure includes: a porous polymer substrate; and a porous coating layer formed on at least one surface of the porous polymer substrate and including inorganic particles. The dielectric constant of the porous coating layer is about 250 to 10,000. The separator according to one embodiment of the present disclosure may further include an electrode adhesive layer formed on at least one surface of the porous coating layer.

According to one embodiment of the present disclosure, the separator for the electrochemical device includes the porous polymer substrate. The porous polymer substrate is a porous film in which a plurality of pores is formed, and may electrically insulate a positive electrode and a negative electrode of the electrochemical device from each other to prevent a short circuit. For example, when the electrochemical device is a lithium secondary battery, the porous polymer substrate may be an ion-conducting barrier that blocks an electrical contact between a positive electrode and a negative electrode while allowing lithium ions to pass. At least a part of the pores may form a three-dimensional network through which the surface of the porous polymer substrate communicates with the inside, and then a fluid can pass through the porous polymer substrate via the pores.

As for the porous polymer substrate, a material physically and chemically stable against an electrolyte that is an organic solvent may be used. For example, the porous polymer substrate may include resins such as a polyolefin-based resin, for example, polyethylene, polypropylene, and polybutylene, polyvinyl chloride, polyethylene terephthalate, polycycloolefin, polyethersulfone, polyamide, polyimide, polyimide amide, nylon, polytetrafluoroethylene, and copolymers or mixtures thereof, but are not limited thereto. For example, as for the porous polymer substrate, the polyolefin-based resin may be used. The polyolefin-based resin is suitable for manufacturing an electrochemical device with higher energy density because this resin can be processed into a relatively thin thickness and allows easy application of the coating slurry.

The porous polymer substrate may have a single-layer or multi-layer structure. The porous polymer substrate may include two or more polymer resin layers with different melting points (Tm), thereby providing a shutdown function in the event of a high-temperature runaway of a battery. For example, the porous polymer substrate may include a polypropylene layer having a relatively high melting point and a polyethylene layer having a relatively low melting point. According to one embodiment, the porous polymer substrate may have a three-layer structure in which polypropylene, polyethylene, and polypropylene are sequentially stacked. The polyethylene layer melts as the temperature of the battery is increased to a predetermined temperature or more, so that the pores may be shut down, thereby preventing the thermal runaway of the battery.

The porous polymer substrate may include pores having an average diameter of about 0.01 μm to 1 μm. For example, the size of the pore included in the porous polymer substrate may be about 0.01 μm to 0.09 μm, 0.02 μm to 0.08 μm, 0.03 μm to 0.07 μm, or 0.04 μm to 0.06 μm. According to one embodiment, the size of the pore may be about 0.02 μm to 0.06 μm. By controlling the pore size of the porous polymer substrate within the above-described range, the air permeability and ionic conductivity of the entire separator for the electrochemical device may be controlled.

The porous polymer substrate may have air permeability of about 10 s/100 cc to 200 s/100 cc. For example, the air permeability of the porous polymer substrate may be about 10 s/100 cc to 150 s/100 cc, 20 s/100 cc to 100 s/100 cc, 30 s/100 cc to 90 s/100 cc, or 40 s/100 cc to 80 s/100 cc. According to one embodiment, the air permeability of the porous polymer substrate may be 50 s/100 cc to 80 s/100 cc. When the air permeability of the porous polymer substrate falls within the above-described range, the air permeability of the electrochemical device separator may be provided within a range suitable for securing the output and cycle characteristics of the electrochemical device.

The air permeability (s/100 cc) refers to the time (sec) it takes for 100 cc of air to pass through the porous polymer substrate or the electrochemical device separator having a predetermined area under a constant pressure. The air permeability may be measured using an air permeability tester (Gurley densometer) in accordance with ASTM D726-58, ASTM D726-94 or JIS-P8117. For example, 4110 N equipment of Gurley may be used to measure the time it takes for 100 cc of air to pass through a 1-square-inch (or 6.54 cm²) sample under a pressure of 0.304 kPa of air or 1.215 kN/m² of water. For example, EG01-55-1MR equipment of ASAHI SEIKO Co., LTD may be used to measure the time it takes for 100 cc of air to pass through a 1-square-inch sample under a constant pressure of 4.8 inches of water at room temperature.

The porous polymer substrate may have a porosity of 10 vol % to 70 vol %. For example, the porosity of the porous polymer substrate may be about 20 vol % to 60 vol %, 30 vol % to 60 vol %, 40 vol % to 55 vol %, or 40 vol % to 50 vol %. According to one embodiment, the porosity of the porous polymer substrate may be about 40 vol % to 60 vol %. When the porosity of the porous polymer substrate falls within the above-described range, the ionic conductivity of the electrochemical device separator may be provided within a range suitable for securing the output and cycle characteristics of the electrochemical device.

The porosity refers to the ratio of the volume of pores to the total volume of the porous polymer substrate. The porosity may be measured by a method known in the present technical field. For example, the measurement may be performed by a Brunauer Emmett Teller (BET) measurement method using adsorption of nitrogen gas, a capillary flow porometry, or a water or mercury intrusion method.

The thickness of the porous polymer substrate may be about 1 μm to 20 μm. For example, the thickness of the porous polymer substrate may be about 2 μm to 20 μm, 3 μm to 19 μm, 4 μm to 18 μm, 5 μm to 17 μm, 6 μm to 16 μm, 7 μm to 15 μm, or 8 μm to 14 μm. By controlling the thickness of the porous polymer substrate within the above-described range, the energy density and ionic conductivity of the electrochemical device may be improved.

According to one embodiment of the present disclosure, the separator for the electrochemical device includes the porous coating layer formed on at least one surface of the porous polymer substrate. The porous coating layer may be disposed on one surface or both surfaces of the porous polymer substrate. The porous coating layer may be disposed on at least a portion of the porous polymer substrate. The porous coating layer may improve the heat resistance of the separator for the electrochemical device, thereby providing high-temperature dimensional stability. Also, the porous coating layer may improve the mechanical properties of the separator for the electrochemical device, thereby improving the stability.

According to one embodiment of the present disclosure, the dielectric constant of the porous coating layer may be about 250 to 10,000. For example, the dielectric constant of the porous coating layer may be about 250 to 5,000, 250 to 3,000, 250 to 1,000, 300 to 5,000, 300 to 3,000, 300 to 1,000, 350 to 1,000, 350 to 900, or 500 to 900. When the dielectric constant of the porous coating layer satisfies the above-described range, a spontaneous polarization state is exhibited during immersion in the electrolyte, thereby causing interactions with polar molecules and ions. Due to the interactions, the decomposition of the salts in the electrolyte is suppressed, thereby preventing or suppressing the side reactions. Then, it is possible to reduce the amount of gases that may be generated during the storage or operation of the electrochemical device.

According to one embodiment of the present disclosure, the porous coating layer includes inorganic particles. For example, the inorganic particles may include BaTiO₃ or SrTiO₃. When the inorganic particles include BaTiO₃ or SrTiO₃, the dielectric constant of the porous coating layer may be adjusted to a desirable range, thereby reducing the amount of gases generated in the electrochemical device.

According to one embodiment of the present disclosure, the dielectric constant of the inorganic particles included in the porous coating layer may be about 250 to 10,000. For example, the dielectric constant of the inorganic particles may be about 500 to 10,000, 600 to 10,000, 1,000 to 10,000, 250 to 3,000, 500 to 3,000, 600 to 3,000, or 1,000 to 3,000. By adjusting the dielectric constant of the inorganic particles to the above-described range, it is possible to suppress side reactions of lithium ions and electrolyte salts within the electrochemical device. Also, when the dielectric constant of the inorganic particles satisfies the above-described range, it is possible to improve the ionic conductivity of the separator for the electrochemical device, and to reduce gases generated during assembly or operation of the electrochemical device.

According to one embodiment of the present disclosure, the crystal structure of the inorganic particles may be tetragonal. When the inorganic particles form a tetragonal crystal structure, high dielectric properties may be exhibited and then a dielectric constant value within the above-described range may be obtained. Accordingly, it is possible to reduce side reactions of lithium ions and electrolyte salts within the electrochemical device.

For example, the tetragonal crystal structure of BaTiO₃ may have a high dielectric constant. The high dielectric constant of the BaTiO₃ tetragonal structure may improve the degree of dissociation of Li ions inside the electrochemical device and suppress the generation of PF₅. Then, it is possible to reduce the hydrolysis reaction of PF₅ and the side reactions of hydrolysis products (e.g., HF generation, HPO₂F₂ generation, and the like). Also, the ionic conductivity within the electrochemical device may be increased, which may not only prevent an increase in resistance inside the electrochemical device, but also reduce gases generated by electrolyte salt decomposition inside the electrochemical device.

According to one embodiment of the present disclosure, the particle size of the inorganic particles may be about 300 nm to 1,000 nm. For example, the particle size of the inorganic particles may be about 300 nm to 900 nm, 300 nm to 800 nm, 300 nm to 700 nm, 300 nm to 600 nm, 350 nm to 800 nm, 350 nm to 600 nm, 400 nm to 800 nm, or 400 nm to 600 nm. Within the above-described range of the particle size of the inorganic particles, it is possible to prevent or suppress the problem of stability degradation. This problem may be caused by a decrease in dielectric constant of the porous coating layer when surface defects occur due to an increase in particle surface area. Also, when the particle size of the inorganic particles satisfies the above-described range, uniform dispersion may be easy in the porous coating layer. In this manner, when the inorganic particles satisfy the above-described particle size range, the dielectric constant of the porous coating layer may fall within an excellent range. Then, it is possible to reduce the generation of gases within the electrochemical device while improving the heat resistance characteristics of the separator for the electrochemical device.

According to one embodiment of the present disclosure, the porous coating layer may contain the inorganic particles in an amount of about 80 parts to 99 parts by weight relative to 100 parts by weight of the porous coating layer. For example, the porous coating layer may contain the inorganic particles in an amount of about 80 parts to 99 parts by weight, 85 parts to 99 parts by weight, 90 parts to 99 parts by weight, 80 parts to 97 parts by weight, 85 parts to 97 parts by weight, 90 parts to 97 parts by weight, 95 parts to 97 parts by weight, 90 parts to 95 parts by weight, or 95 parts to 97 parts by weight, relative to 100 parts by weight of the porous coating layer. When the range of the parts by weight of the inorganic particles satisfies the above-described range, the heat resistance may be imparted to the electrochemical device while the dielectric constant of the porous coating layer may be adjusted to the above-described range, thereby reducing the amount of gases generated in the electrochemical device.

According to one embodiment of the present disclosure, the porous coating layer may contain BaTiO₃ as inorganic particles. BaTiO₃ has high stability at high temperatures, and thus can improve the heat resistance of the electrochemical device. Also, through the adjustment of the particle size and crystal structure, BaTiO₃ may have a high dielectric constant. Then, when BaTiO₃ is included in the porous coating layer, it is possible to reduce side reactions within the electrochemical device.

According to one embodiment of the present disclosure, the crystal structure of BaTiO₃ may be a tetragonal structure. When the porous coating layer includes BaTiO₃ having a tetragonal structure, as inorganic particles, a high dielectric constant of the electrochemical device may be maintained, thereby reducing the amount of generated gases,

According to one embodiment of the present disclosure, the particle size of BaTiO₃ may be about 300 nm to 1,000 nm. For example, the particle size of BaTiO₃ may be about 300 nm to 900 nm, 300 nm to 800 nm, 300 nm to 700 nm, 300 nm to 600 nm, 350 nm to 800 nm, 350 nm to 600 nm, 400 nm to 800 nm, or 400 nm to 600 nm. When the particle size of BaTiO₃ satisfies the above-described range, the asymmetry level of the Ti element within the BaTiO₃ particles may be maintained at an appropriate level, thereby preventing or suppressing a decrease in dielectric constant of the porous coating layer. Also, when the particle size of BaTiO₃ satisfies the above-described range, uniform dispersion is possible within the porous coating layer. In this manner, when the particle size of BaTiO₃ satisfies the above-described range, it is possible to maintain the heat resistance of the separator for the electrochemical device while improving the effect of reducing the amount of generated gases.

According to one embodiment of the present disclosure, the dielectric constant of BaTiO₃ may be about 250 to 10,000. For example, the dielectric constant of BaTiO₃ may be about 500 to 10,000, 600 to 10,000, 1,000 to 10,000, 250 to 3,000, 500 to 3,000, 600 to 3,000, or 1,000 to 3,000. When the above-described range is satisfied, it is possible to maintain a high ionic conductivity of the electrochemical device separator while reducing gases generated inside the electrochemical device.

According to one embodiment of the present disclosure, the density of the inorganic particles within the coating layer may be the same or different depending on the region of the porous coating layer. For example, the density of the inorganic particles in the region near the porous polymer substrate may be higher than the density of the inorganic particles in the region near the electrode, or the density of the inorganic particles in the region near the electrode may be higher than the density of the inorganic particles in the region near the porous polymer substrate.

According to one embodiment of the present disclosure, the porous coating layer may further include inorganic particles other than BaTiO₃ or SrTiO₃. Examples thereof may include Pb(Zr,Ti)O₃ (PZT), Pb₁₋ₓLaₓZr_{1-y}Ti_{y}O₃ (PLZT, 0<x<1, and 0<y<1), Pb(Mg_{1/3}Nb_{2/3})O₃—PbTiO₃(PMN-PT), hafnia (HfO₂), SnO₂, CeO₂, MgO, Mg(OH)₂, NiO, CaO, ZnO, ZrO₂, SiO₂, Y₂O₃, Al₂O₃, SiC, Al(OH)₃, TiO₂, aluminum peroxide, zinc tin hydroxide (ZnSn(OH)₆), tin-zinc oxide (Zn₂SnO₄ and ZnSnO₃), antimony trioxide (Sb₂O₃), antimony tetroxide (Sb₂O₄), and antimony pentoxide (Sb₂O₅), and among these, one or two or more may be further included. When the separator for the electrochemical device includes the above-described inorganic materials, high-temperature stability may be provided.

According to one embodiment of the present disclosure, the porous coating layer may contain the inorganic particles and a polymer binder. The inorganic particles may be linked to other inorganic particles by the polymer binder to form an interstitial volume, and lithium ions may move through the interstitial volume.

The polymer binder may be a solution-type binder that is dissolved in a dispersion medium of the coating slurry, a particle-type binder that is not dissolved in a dispersion medium and maintains its particle shape in the coating slurry and the porous coating layer, or a combination thereof, but is not limited thereto. The polymer binder may include an acrylic binder, a fluorine-based binder, or a mixed binder thereof, but is not limited thereto. For example, the acrylic binder may be at least one selected from polyacrylic acid, polyacrylamide, methyl acrylate, ethyl acrylate, isopropyl acrylate, n-butyl acrylate, isobutyl acrylate, ethylhexyl acrylate, methyl methacrylate, styrene-butadiene rubber, nitrile-butadiene rubber, acrylonitrile-butadiene rubber, acrylonitrile-butadiene-styrene rubber, and a copolymer containing at least one of these. For example, the fluorine-based binder may be at least one selected from polyvinylidene fluoride, polyvinylidene fluoride-hexafluoropropylene, and polyvinylidene fluoride-trichloroethylene. According to one embodiment, the polymer binder may be an acrylic binder. By being combined with inorganic particles satisfying the range of the dielectric constant, the polymer binder that is an acrylic binder may form an appropriate interstitial volume, and improve adhesion to the electrode or the porous polymer substrate.

According to one embodiment of the present disclosure, in the porous coating layer, the polymer binder may be included in an amount of about 3 parts to 20 parts by weight relative to 100 parts by weight of the porous coating layer. For example, in the porous coating layer, the content of the polymer binder may be about 3 parts to 15 parts by weight, 3 parts to 10 parts by weight, 5 parts to 20 parts by weight, 5 parts to 15 parts by weight, 10 parts to 20 parts by weight, 10 parts to 15 parts by weight, 15 parts to 20 parts by weight, 7 parts to 16 parts by weight, or 10 parts to 13 parts by weight relative to 100 parts by weight of the porous coating layer. When the above-described range is satisfied, the ease of assembly may be improved in the assembly process of the electrode.

According to one embodiment of the present disclosure, the thickness of the porous coating layer may be about 0.3 μm to 3.0 μm. For example, the thickness of the porous coating layer may be about 0.6 μm to 1.4 μm, 0.7 μm to 1.3 μm, 0.8 μm to 1.2 μm, 0.9 μm to 1.1 μm, 0.5 μm to 0.8 μm, 0.5 μm to 1.1 μm, 0.5 μm to 2 μm, 0.5 μm to 2.5 μm, or 1.0 μm to 2.5 μm. When the above-described range is satisfied, the separator for the electrochemical device may be kept relatively thin while the mechanical strength may be maintained. Also, the thin thickness of the electrochemical device separator may improve the ionic conductivity of the electrochemical device separator, and may reduce the internal resistance of the electrochemical device. Therefore, it is possible to increase the stability and efficiency of the electrochemical device.

According to one embodiment of the present disclosure, the amount of gases generated in the electrochemical device separator may be about 1,500 μl or less. For example, the gas generation amount of the electrochemical device separator may be 1,200 μl or less, 1,000 μl or less, or 800 μl or less, or may be greater than 0 μl, 100 μl or more, 300 μl or more, 500 μl or more, or 700 μl or more. In order to measure the gas generation amount, the electrochemical device separator is sampled with an area of 560 cm² using, for example, BGA-06 equipment, and the sampled separator is put in a 21700-sized cylindrical can together with an electrolyte. Then, the can is stored at room temperature for 12 h and in a chamber of 130° C. for 1 h, and the gases generated inside the can are collected. The electrolyte to be used may be obtained by adding 1.2 mol of lithium salt LiPF₆ to a solvent in which ethylene carbonate and ethyl methyl carbonate are mixed at a volume ratio of 3:7.

The porous coating layer may be formed through a method of coating at least one surface of the porous polymer substrate with the coating slurry containing the inorganic particles, the polymer binder, and the dispersion medium. For example, the coating may be formed through methods such as a bar coater, a wire bar coater, a roll coater, a spray coater, a spin coater, an inkjet coater, a screen coater, a reverse coater, a gravure coater, a knife coater, a slot die coater, a hot melt coater, a comma coater, and a direct metering coater, but the present disclosure is not limited thereto. When the above-described coating methods are used, it is possible to easily form the porous coating layer on the porous polymer substrate.

According to one embodiment of the present disclosure, the electrochemical device separator may further include an electrode adhesive layer that is formed on the upper surface of the porous coating layer. The electrode adhesive layer may include a binder for the electrode adhesive layer. The binder for the electrode adhesive layer may include a fluorine-based binder and an acrylic binder, thereby improving adhesion to the electrode. According to one embodiment, the electrode adhesive layer may include an acrylic binder. When the electrode adhesive layer includes the fluorine-based binder and the acrylic binder, it is possible to stably maintain the adhesion of the electrochemical device separator to the electrode both in a dry state without an electrolyte and in a wet state caused by soaking in an electrolyte. For example, the electrode adhesive layer may include the fluorine-based binder and the acrylic binder in a weight ratio of about 1:9 to 9:1. The electrode adhesive layer may be formed with a small thickness compared to the porous coating layer, so that it is possible to minimize the reduction of the air permeability of the electrochemical device separator while providing adhesion to the electrode.

The electrode adhesive layer may be formed by additionally applying the binder for the electrode adhesive layer to the surface of the porous coating layer. For example, the electrode adhesive layer may be formed by using spraying, gravure coating, slot die, etc. but the present disclosure is not limited thereto.

A cylindrical lithium secondary battery according to one embodiment of the present disclosure is an electrochemical device that includes a positive electrode, a negative electrode, and a separator interposed between the positive electrode and the negative electrode. The separator is the above-described separator for the electrochemical device according to the embodiment. The cylindrical lithium secondary battery may be manufactured by inserting an electrode assembly into a battery case and sealing the battery case. The electrode assembly includes the positive electrode, the negative electrode, and the separator interposed between the positive electrode and the negative electrode. Before the battery case is sealed, an electrolyte is injected such that the electrode assembly may be soaked in the electrolyte.

Meanwhile, in the present embodiment, as for the electrochemical device, a cylindrical lithium secondary battery has been exemplified. However, the present disclosure is not limited thereto, and the electrochemical device may be another type of secondary battery, for example, a prismatic, coin-shaped or pouch-shaped lithium secondary battery.

Each of the positive electrode and the negative electrode may include an electrode active material coated on at least one surface of a current collector, which is obtained through application and drying. As for the current collector, a material that has conductivity without causing chemical changes in the electrochemical device may be used. Examples of the current collector for the positive electrode may include aluminum, nickel, titanium, baked carbon, and stainless steel; and aluminum or stainless steel whose surface is treated with carbon, nickel, titanium, silver, etc., but are not limited to these. Examples of the current collector for the negative electrode may include copper, nickel, titanium, baked carbon, and stainless steel; and copper or stainless steel whose surface is treated with carbon, nickel, titanium, silver, etc., but are not limited to these. The current collector may have various forms such as a metal thin plate, a film, a foil, a net, a porous body, and a foam.

The positive electrode includes a positive electrode current collector and a positive electrode active material layer on at least one surface of the current collector. The layer contains a positive electrode active material, a conductive material, and a binder resin. The positive electrode active material may include one type or a mixture of two or more types among layered compounds such as lithium manganese composite oxide (LiMn₂O₄, LiMnO₂, etc.), lithium cobalt oxide (LiCoO₂), and lithium nickel oxide (LiNiO₂) or compounds substituted with one or more transition metals; lithium manganese oxide such as chemical formulas Li₁₊ₓMn₂₋ₓO₄ (where x is 0 to 0.33), LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇; Ni site-type lithium nickel oxide represented by a chemical formula LiNi₁₋ₓMₓO₂ (where M=Co, Mn, Al, Cu, Fe, Mg, B, or Ga, x=0.01 to 0.3); lithium manganese composite oxide represented by a chemical formula LiMn₁₋ₓMₓO₂ (where M=Co, Ni, Fe, Cr, Zn, or Ta, x=0.01 to 0.1) or Li₂Mn₃MO₈ (where M=Fe, Co, Ni, Cu, or Zn); LiMn₂O₄ in which a part of Li in the chemical formula is substituted with an alkaline earth metal ion; a disulfide compound; and Fe₂(MoO₄)₃.

The negative electrode includes a negative electrode current collector and a negative electrode active material layer on at least one surface of the negative electrode current collector. The layer contains a negative electrode active material, a conductive material, and a binder resin. The negative electrode may include, as the negative electrode active material, one type or a mixture of two or more types selected among lithium metal oxides; carbon such as non-graphitizable carbon, or graphite-based carbon; metal composite oxides such as LixFe₂O₃ (0≤x≤1), LiₓWO₂ (0≤x≤1), and SnₓMe₁₋ₓMe′_{y}O_{z} (Me: Mn, Fe, Pb, or Ge; Me′: Al, B, P, Si, elements belonging to groups 1, 2, and 3 of the periodic table, or halogen; 0<x≤1; 1≤y≤3; and 1≤z≤8); silicon-based materials such as Si, SiOₓ (0<x<2), SiC, and Si alloys; lithium metal; lithium alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxide.

The conductive material may be any one selected from graphite, carbon black, carbon fiber or metal fiber, metal powder, conductive whiskers, conductive metal oxide, carbon nanotubes, activated carbon, and polyphenylene derivatives, or a mixture of two or more types of conductive materials among these. The carbon nanotube has a graphite sheet in the cylinder shape with a nano-sized diameter, and has a sp² bonding structure. Depending on the rolling angle and structure of the graphite sheet, the carbon nanotube exhibits the characteristics of a conductor or a semiconductor. Carbon nanotubes may be classified into single-walled carbon nanotubes (SWCNTs), double-walled carbon nanotubes (DWCNTs), and multi-walled carbon nanotubes (MWCNTs) depending on the number of bonds forming walls, and these carbon nanotubes may be appropriately selected depending on the intended use of the dispersion. According to one embodiment, the conductive material may be one type selected from natural graphite, artificial graphite, super-p, acetylene black, Ketjen black, channel black, furnace black, lamp black, thermal black, Denka black, aluminum powder, nickel powder, zinc oxide, potassium titanate, and titanium oxide, or a mixture of two or more types of conductive materials among these.

The electrolyte includes a salt having a structure such as A⁺B⁻, which may be dissolved or dissociated in an organic solvent, but the present disclosure is not limited thereto. A⁺ may include alkali metal cations such as Li⁺, Na⁺, and K⁺ or ions composed of combinations thereof, and B⁻ may include anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻ or ions composed of combinations thereof. The organic solvent includes propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), gamma butyrolactone, or a mixture thereof. According to one embodiment, the electrolyte may contain LiPF₆. When the electrolyte contains LiPF₆, BaTiO₃ may suppress side reactions of PF₆ ions, thereby reducing side reactions inside the electrochemical device. According to one embodiment, the solvent may contain a carbonate-based solvent. When the solvent contains the carbonate-based solvent, a reaction between the carbonate-based solvent and salt decomposition products may be prevented or suppressed, thereby reducing the generation of gases inside the electrochemical device.

The separator for the electrochemical device may have air permeability of about 30 sec/100 cc to 300 sec/100 cc. For example, the air permeability may be about 50 sec/100 cc to 150 sec/100 cc, 40 sec/100 cc to 150 sec/100 cc, 80 sec/100 cc to 200 sec/100 cc, 100 sec/100 cc to 300 sec/100 cc, 150 sec/100 cc to 300 sec/100 cc, or 200 sec/100 cc to 300 sec/100 cc. Within the above-described range of the air permeability, the stability may be secured in the separator for the electrochemical device, and at the same time, the output and cycle characteristics of the electrochemical device may be secured.

According to one embodiment of the present disclosure, the electrochemical device may be manufactured by inserting an electrode assembly into a case and sealing the case. The electrode assembly includes the positive electrode, the negative electrode, and the electrochemical device separator interposed between the positive electrode and the negative electrode. Before the sealing after the insertion of the electrode assembly into the case, an electrolyte is injected such that the electrode assembly may be soaked in the electrolyte.

The electrochemical device including the electrode assembly may be a lithium secondary battery. The battery may be used as a unit cell, and may be used for a battery module including the unit cell, a battery pack including the battery module, or a device including the battery pack as a power source. Examples of the device may include: small devices such as computers, mobile phones, and power tools; and medium to large devices, for example, electric vehicles powered and driven by electrical motors, which include an electric vehicle (EV), a hybrid electric vehicle (HEV), a plug-in hybrid electric vehicle (PHEV), etc.; electric two-wheeled vehicles including an electric bicycle (E-bike) and an electric scooter (E-scooter); an electric golf cart; and a power storage system, but are not limited to these.

Hereinafter, the present disclosure will be described in more detail through Examples, Comparative Examples, and Experimental Examples. The following examples, comparative examples, and experimental examples are intended to illustrate the present disclosure, and the present disclosure is not limited by the following examples, comparative examples, and experimental examples.

### Example 1

### Preparation of Coating Slurry

At room temperature (25° C.), BaTiO₃ with a tetragonal crystal structure (particle size: 600 nm, dielectric constant: 2000), as inorganic particles, and a polyacrylic acid-based dispersant were put and were stirred by a shaker for 120 min to prepare an inorganic dispersion. An acrylic binder (styrene-butyl acrylate, Tg: −35° C.) and a wetting agent (Si-based) were added to the dispersion and were stirred for 30 min to prepare a coating slurry. Here, the weight ratio of solids contained in the coating slurry is inorganic particles:binder:dispersant:wetting agent=95:4.4:0.5:0.1.

### Preparation of Porous Polymer Substrate

As for a porous polymer substrate, a polyethylene film with a size of 20 cm×30 cm and a thickness of 10 μm was used (MI: 0.02 g/10 min, Tₘ: 135° C., porosity: 55 vol %, average pore size: 50 nm).

### Formation of Porous Coating Layer

The coating slurry was coated on both surfaces of the polyethylene film by using a bar coater and then was dried through application of low-temperature airflow. Here, the surface temperature of a porous coating layer was adjusted not to exceed 60° C. Then, a porous coating layer having each coating thickness of 1.5 μm was formed.

### Manufacturing of Electrochemical Device

Two separators obtained from the foregoing, one positive electrode (a thickness of 158.3 μm), and two negative electrodes (a thickness of 225.3 μm) were prepared. The positive electrode and the negative electrode were alternately arranged, and the separator was disposed between the positive electrode and the negative electrode. Stacking was performed in this manner to prepare a stack.

The stack was mounted on a pressing device, and was laminated at 75° C. and a pressure of 8.4 MPa for 1 sec. Then, an electrochemical device was manufactured.

### Example 2

An electrochemical device was manufactured in the same manner as in Example 1 except that as for the inorganic particles, BaTiO₃ with a tetragonal crystal structure (particle size: 400 nm, dielectric constant: 1,300) was used.

### Example 3

An electrochemical device was manufactured in the same manner as in Example 1 except that as for the inorganic particles, SrTiO₃ with a tetragonal crystal structure (particle size: 500 nm, dielectric constant: 3,000) was used.

### Example 4

An electrochemical device was manufactured in the same manner as in Example 1 except that in Example 1, instead of the acrylic binder, a fluorine-based polymer binder (PVDF-HFP) was used.

### Comparative Example 1

Comparative Example 1 was designed to evaluate a gas generation amount of a lithium salt, and an electrolyte was prepared by adding 1.2 mol of lithium salt LiPF₆ to a solvent in which ethylene carbonate and ethyl methyl carbonate were mixed at a volume ratio of 3:7.

### Comparative Example 2

An electrochemical device was manufactured in the same manner as in Example 1 except that as for the inorganic particles, Al₂O₃ (particle size: 500 nm, dielectric constant: 9) was used.

### Comparative Example 3

An electrochemical device was manufactured in the same manner as in Example 1 except that as for the inorganic particles, AlOOH (particle size: 450 nm, dielectric constant: 5.5) was used.

### Comparative Example 4

An electrochemical device was manufactured in the same manner as in Example 1 except that as for the inorganic particles, BaTiO₃ with a cubic crystal structure (particle size: 150 nm, dielectric constant: 150) was used.

### Comparative Example 5

An electrochemical device was manufactured in the same manner as in Example 1 except that as for the inorganic particles, BaTiO₃ with a tetragonal crystal structure (particle size: 300 nm, dielectric constant: 600) was set.

### Experimental Example

### Measurement of Dielectric Constant of Porous Coating Layer

The porous coating layers of the separators in Examples 1 to 4 and Comparative Examples 2 to 5 were obtained as specimens, and the dielectric constant was measured at a temperature of 25° C. through a standard test method of ASTM D150.

### Measurement of Air Permeability

The air permeability of the separator in Examples and Comparative Examples was measured using a Gurley densometer (Gurley, 4110N). That is, the time it took for 100 cc of air to pass through a separator with a diameter of 28.6 mm and an area of 645 mm² was measured. The measurement results are noted in Table 1 below.

### Measurement of Gas Generation Amount

The electrolyte of Comparative Example 1 was sampled into a 21700-sized cylindrical can and sealed, and then stored at room temperature for 12 h. Next, after storage in a chamber of 130° C. for 1 h, the gases generated inside the can were collected using a BGA-06 device, and the gas generation amount was measured. The gas generation amount in Comparative Example 1 was measured to be 730 μl.

For Examples 1 to 4 and Comparative Examples 2 to 5, the gas generation amount was measured in the same manner as in Comparative Example 1 except that sampling was performed using a separator with an area of 560 cm².

### Measurement of Thermal Shrinkage Rate at 180° C.

The separator in Examples and Comparative Examples was cut into a size of 50 mm×50 mm to prepare a specimen. This specimen was kept in an oven heated to 180° C. for 30 min, and then was recovered. Then, the changed lengths in the machine direction (MD) and the transverse direction (TD) were measured and calculation was carried out as in Equation 1:

$$Thermal shrinkage rate at 180 ° C . ( \% ) = \{ ( Dimension before shrinkage - Dimension after shrinkage ) / Dimension before shrinkage \} \times 100 \qquad [ Equation 1 ]$$

TABLE 1

| | | Example | Example | Example | Example | Comparative | Comparative | Comparative | Comparative |
|---|---|---|---|---|---|---|---|---|---|
| | | 1 | 2 | 3 | 4 | example 2 | example 3 | example 4 | example 5 |
| Porous | Dielectric Constant | 500 | 350 | 850 | 900 | 8 | 5 | 60 | 200 |
| Coating Layer | Thickness (μm) | 1.5/1.5 | 1.5/1.5 | 1.5/1.5 | 1.5/1.5 | 1.5/1.5 | 1.5/1.5 | 1.5/1.5 | 1.5/1.5 |
| Inorganic | Type | BaTiO₃ | BaTiO₃ | SrTiO₃ | BaTiO₃ | Al₂O₃ | AlOOH | BaTiO₃ | BaTiO₃ |
| Particles | Crystal structure | Tetragonal | Tetragonal | Tetragonal | Tetragonal | — | — | Cubic | Tetragonal |
| | Particle Size (nm) | 600 | 400 | 500 | 600 | 500 | 450 | 150 | 300 |
| | Dielectric Constant | 2,000 | 1,300 | 3,000 | 2,000 | 9 | 5.5 | 150 | 600 |

| | | | | | | | | |
|---|---|---|---|---|---|---|---|---|
| Polymer Binder | Acrylic | Acrylic | Acrylic | Fluorine- | Acrylic | Acrylic | Acrylic | Acrylic |
| | | | | based | | | | |
| Air Permeability (sec/100 cc) | 93 | 95 | 92 | 94 | 90 | 85 | 112 | 100 |
| Gas Generation Amount (μl) | 800 | 1,500 | 800 | 830 | 4700 | 7800 | 2300 | 1850 |
| Thermal Shrinkage Rate (%, MD/TD) | 3/2 | 2/2 | 2/2 | 2/2 | 8/5 | 15/10 | 2/1 | 2/1 |

Referring to Table 1, in the case of Examples 1 to 4, the porous coating layer employed in the separator contained a material having a dielectric constant of about 250 to 10,000 (e.g., BaTiO₃ or SrTiO₃), as for inorganic particles, and had a dielectric constant of about 250 to 10,000. It was found that the gas generation amount of the separator reached the level of 800 μl to 1,500 μl, which was significantly reduced compared to the case of Comparative Examples 1 to 4 in which the gas generation amount was 1,850 μl to 7,800 μl.

In this manner, it can be found that when the dielectric constant of the porous coating layer of the separator is adjusted to an appropriate range, it is possible to improve the stability of the electrochemical device employing the same.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A separator for an electrochemical device comprising:
a porous polymer substrate; and
a porous coating layer formed on at least one surface of the porous polymer substrate and containing inorganic particles,
wherein the dielectric constant of the porous coating layer is 250 to 10,000.

2. The separator for the electrochemical device according to claim 1, wherein the inorganic particles contain BaTiO₃ or SrTiO₃.

3. The separator for the electrochemical device according to claim 2, wherein the inorganic particles have a dielectric constant of 250 to 10,000.

4. The separator for the electrochemical device according to claim 2, wherein the particle size of the inorganic particles is 300 nm to 1,000 nm.

5. The separator for the electrochemical device according to claim 2, wherein the crystal structure of the inorganic particles is tetragonal.

6. The separator for the electrochemical device according to claim 1, wherein the thickness of the porous coating layer is 0.3 μm to 3.0 μm.

7. The separator for the electrochemical device according to claim 1, wherein the inorganic particles are included in an amount of 80 parts to 99 parts by weight relative to 100 parts by weight of the porous coating layer.

8. The separator for the electrochemical device according to claim 1, wherein the porous coating layer further includes an acrylic binder.

9. The separator for the electrochemical device according to claim 1, wherein the gas generation amount of the separator for the electrochemical device is 1,500 μl or less.

10. An electrochemical device comprising:
a positive electrode, a negative electrode, a separator disposed between the positive electrode and the negative electrode, and an electrolyte,
wherein the separator is the separator according to claim 1.

11. The electrochemical device according to claim 10, wherein the electrochemical device is a lithium secondary battery.
